(19) United States
(12) Patent Application Publication
(10) Pub. No.: US 2009/0252841 A1
(43) Pub. Date: Oct. 8, 2009

(54) FRUIT OR VEGETABLE AND GRAIN SNACK MIXTURE

(76) Inventors: Varadharajan Radhami Basker, Plano, TX (US); Jason Thomas Niermann, Frisco, TX (US)

Correspondence Address: CARSTENS & CAHOON, LLP, P O BOX 802334, DALLAS, TX, 75380, US

(21) Appl. No.: 12/099,235

(22) Filed: Apr. 8, 2008

(51) Int. Cl. A23L 1/2165

(52) U.S. Cl. 426/231; 426/615; 426/519

(57) ABSTRACT

The present invention discloses formulations for a snack mixture having a grain component and a high content of fruit or vegetables. Fruit or vegetable based snack chips and various types of dehydrated fruit or vegetable pieces are combined with grain-based snack pieces to provide a nutritious snack mixture.

### BACKGROUND OF THE INVENTION

1. Technical Field

The present invention relates to an improved snack food mixture and more particularly to a mixture of different snack pieces that incorporates a grain component along with a high fruit or vegetable content.

2. Description of Related Art

Snack food items that are typically sold to consumers take the form of snack chips or other discrete, crispy snack sized pieces of food. Furthermore, these snack sized pieces of food are sold to consumers in packages that contain a single type of snack food item. For example, a store shelf could be stocked with several packages of nacho cheese flavored tortilla chips, several packages of plain tortilla chips, and several packages of corn chips.

Sometimes, however, different snack food items are mixed together before packaging. One example of a snack food mixture is known colloquially as trail mix. Trail mix is a mixture of nuts, such as peanuts or cashews, and partially dried fruit, like raisins or dried cranberries.

Fruits and vegetables are generally good sources of vitamins, minerals and other healthy compounds such as anti-oxidants. Different fruits and vegetables are rich in different nutrients, and the United States Department of Agriculture (USDA) recommends consumption of between 5 and 13 servings of a variety of fruits and vegetables per day, depending on the specific individual's needs. According to the Food and Drug Administration, a diet that is high in fiber can reduce a person's risk of certain cancers, diabetes, digestive disorders, and heart diseases, as well as aid weight management. Furthermore, vitamins and minerals are widely recognized as part of a healthy diet, and antioxidants may reduce the risk of heart disease and cancer.

However, the dried fruits in trail mix do not provide a meaningful amount of fruit per one ounce serving of trail mix, nor does it typically provide a wide variety of fruits. Furthermore, peanuts, cashews, raisins and cranberries all have moisture contents above 5% by weight. Therefore, trail mix does not contain the crispy foods mentioned above that are desired be consumers. The present invention is thus directed towards a snack mixture that includes crispy foods, and provides a high level of fruit or vegetables per one ounce serving.

### SUMMARY OF THE INVENTION

The present invention thus provides a great tasting, healthy snack mixture having a high content of fruit or vegetable solids. In one embodiment, the snack mixture of the present invention preferably has at least ½ serving of fruit or vegetables per 1 ounce serving. In another embodiment, the snack mixture of the present invention has at least 1 serving of fruit or vegetables per 1 ounce serving.

In one aspect of the invention, the fruit or vegetable content is provided by three components. The first component is a crispy, fabricated, fruit or vegetable based snack chip that delivers between about ½ and about 1 serving of fruit or vegetables, respectively, per ounce of snack chips. The second component is freeze dried fruit or vegetable pieces, which deliver between about 2 and about 4 servings of fruit or vegetables per ounce of freeze dried fruit or vegetables. The third component is osmotically dehydrated, vacuum fried pieces of fruit or vegetables, which deliver between about 1 and about 2 servings of fruit or vegetables per ounce of vacuum fried fruit or vegetables. These fruit and vegetable components are combined with a grain component to provide consumers with a bite-sized, healthy snack mixture that scores high on consumer tests. These as well as additional features and advantages of the present invention will become apparent in the following written description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flowchart indicating the processing steps for one embodiment of the present invention.

### DETAILED DESCRIPTION

The snack food mixture of the present invention is high in fruit or vegetable content and also comprises a healthy grain-based component. The particular components of the snack mixture disclosed herein were chosen with several considerations in mind. First, the snack mixture was designed to be very healthy by providing the consumer with at least ½ serving of fruit or vegetables per one ounce serving of snack mix. Other nutritional goals for the snack mixture of the present invention include, per 1 ounce serving of snack chips: no more than 5 g of fat, 1 gram or less of saturated fat, zero trans-fatty acids, less than 25% calories from added sugar, no more than 270 milligrams of sodium, and greater than 10% recommended daily value of vitamin C.

Second, consumer perception of the snack mixture was considered. In this regard, the components of the snack mixture were chosen to provide the consumer with a variety of colors, textures and flavors (although the different flavors used should be complimentary). The components chosen are also “bite sized” in that consuming one serving of the snack mixture will preferably involve a high number of hand-to-mouth transfers.

Third, providing value to the consumer was considered. Some of the components of the snack mixture disclosed herein are relatively expensive (such as freeze-dried fruit) while others are relatively inexpensive (such as the grain component). The snack mixture disclosed herein balances the nutritional goals listed above with consumer perception and economic considerations better than any snack mixture known in the prior art.

As used herein, the term fruit is used in the culinary sense and includes those botanical fruits that are sweet and fleshy. Examples of fruit include, without limitation, apple, strawberry, blueberry, cranberry, raspberry, plum, peach, mango, banana, pear, grape and orange. The term vegetable is used herein in the culinary sense and includes those plant fruits that are savory, as opposed to sweet. Examples of vegetables include, without limitation, pumpkin, tomato, onion, bell pepper, beet, cucumber, broccoli and squash. Each of the different fruits and vegetables used in the present invention are rich in different nutrients and thus have different nutritional benefits.

The components of the snack mixture that give it a high content of fruit or vegetables are threefold. One component that contributes to the fruit and vegetable content of the snack mixture is the inclusion of freeze-dried pieces of fruit or vegetables. Another component is provided by osmotically dehydrated, vacuum fried pieces of fruit or vegetables. The third fruit component comes from crispy, baked snack chips that comprise a high level of fruit or vegetable solids per one ounce serving of chips.

In one preferred embodiment, the snack mixture of the present invention incorporates at least ½ serving of fruit or vegetables per 1 ounce serving of the snack mix. In another preferred embodiment, the snack mixture of the present invention incorporates at least 1 serving of fruit or vegetables per 1 ounce serving of the snack mix. The weight ratio of each fruit or vegetable component in the snack mixture is controlled to obtain the desired level of servings. The freeze dried fruit delivers between about 2 and about 4 servings of fruit per ounce of freeze dried fruit. The freeze dried vegetables delivers between about 2 and about 4 servings of vegetables per ounce of freeze dried vegetables. The osmotically dehydrated, vacuum fried fruit delivers between about 1 and about 2 servings of fruit per ounce of said vacuum fried fruit. The osmotically dehydrated, vacuum fried vegetables deliver between about 1 and about 2 servings of vegetables per ounce of said vacuum fried vegetables. The crispy fruit chips deliver between about ½ and about 1 serving of fruit per ounce of fruit chips. The crispy vegetable chips deliver between about ½ and about 1 serving of vegetables per ounce of vegetable chips.

The United States Department of Agriculture (USDA) defines a serving of fruit or vegetables as ½ cup of chopped fruit or vegetables. For example, ½ cup of chopped raw apples constitutes 1 serving of apples under the USDA guidelines. A serving of fruit or vegetables can be understood as having a moisture content and a solids content. Fruit solids are defined herein as the non-water components of fruit. Vegetable solids are defined herein as the non-water components of vegetables. Thus, a serving of fruit comprises a fruit solids content on a dry basis, and a serving of vegetables comprises a vegetable solids content on a dry basis. The USDA National Nutrient Database for Standard Reference defines the weight of the edible portion of a particular fruit or vegetable in that ½ cup and defines the average moisture and thus the solids content of the edible portion of that particular fruit or vegetable. Table 1, for example, depicts the nutrient profile for 1-cup or 125 grams of raw apples as accessed at http://www.nal.usda.gov/fnic/foodcomp/search/.

TABLE 1
Raw Apples

| | | |
|---|---|---|
| | | 1.00 × 1 |
| | | cup, |
| | | chopped |
| | | or sliced |
| Nutrient | Units | 125 g |

Proximates

| | | |
|---|---|---|
| Water | g | 106.95 |
| Energy | kcal | 65 |
| Energy | kj | 272 |
| Protein | g | 0.33 |
| Total lipid (fat) | g | 0.21 |
| Ash | g | 0.24 |
| Carbohydrate, by difference | g | 17.26 |
| Fiber, total dietary | g | 3.0 |
| Sugars, total | g | 12.99 |
| Sucrose | g | 2.59 |
| Glucose (dextrose) | g | 3.04 |
| Fructose | g | 7.38 |
| Lactose | g | 0.00 |
| Maltose | g | 0.00 |
| Galactose | g | 0.00 |
| Starch | g | 0.06 |

### USDA National Nutrient Database for Standard Reference, Release 20 (2007)

As used herein, a serving of fruit is defined as the amount of fruit solids content that is equivalent to ½ cup (118 cubic centimeters) of chopped fruit on a dry basis based on the USDA National Nutrient Database for Standard Reference, Release 20, 2007, which is incorporated herein by reference. Likewise, a serving of vegetables is defined as the amount of vegetable solids content that is equivalent to ½ cup of chopped vegetables on a dry basis based on the USDA National Nutrient Database for Standard Reference, Release 20, 2007. According to Table 1, one cup of chopped or quartered raw apples weighs 125 grams, has a water content of 85.56% by weight and a fruit solids content of 14.44%. One fruit serving of raw apples (½ cup) has a total weight of 62.5 grams. Consequently, 9.025 grams (14.44% solids content×62.5 grams total weight) of apple solids in a finished product is equivalent to one serving of fruit. Thus, a snack piece having a one-half fruit serving would have approximately 4.51 grams of apple solids in a 1 ounce serving of snack pieces, and a snack piece having one fruit serving would have approximately 9.025 grams of apple solids in a 1 ounce serving of snack pieces.

Consequently, in one embodiment, fruit ingredients can be used in accordance with the present invention in an amount sufficient to provide for a one-half fruit serving, and in another preferred embodiment in an amount sufficient to provide for one fruit serving. In another embodiment, vegetable ingredients can be used in accordance with the present invention in an amount sufficient to provide for a one-half vegetable serving, and in another preferred embodiment in an amount sufficient to provide for one vegetable serving.

In one aspect of the present invention, fruit or vegetable based snack chips are included as one component of the snack mixture of the present invention. To make the fruit or vegetable chips, fruit powder or vegetable powder, respectively, is used as an ingredient in dough that is sheeted, cut into pieces of a desirable shape and cooked. The term fruit powder, as used herein, is defined as partially dehydrated flakes of fruit solids or fruit pomace. The term vegetable powder, as used herein, is defined as partially dehydrated flakes of vegetable solids. Fruit and vegetable powder may also contain ingredients such as rice flour and/or lecithin as processing aids.

In one embodiment, the fruit powder contains apple. In another embodiment, the fruit powder contains apple, blueberry, cranberry, and strawberry. In a preferred embodiment, the fruit powder comprises about 80% to about 90% apple, about 3% to about 8% strawberry, about 3% to about 8% blueberry, and about 3% to about 8% cranberry. In still another embodiment, the fruit powder contains apple, peach and mango. In a more preferred embodiment, the fruit powder comprises at least about 95% apple, at least about 1% peach and at least about 1% mango. These ingredients are preferred due to considerations such as flavor (sweetness), cost, color, sugar content and fruit solids content.

In one embodiment, the vegetable powder contains pumpkin, tomato, onion, bell pepper, and beet. In a more preferred embodiment, the vegetable powder comprises about 35% to about 45% pumpkin, about 35% to about 45% tomato, about 10% to about 15% onion, about 5% to about 10% bell pepper, and less than about 3% beet. In another embodiment, the vegetable powder contains pumpkin, tomato, and onion. In a more preferred embodiment, the vegetable powder comprises about 75% to about 85% pumpkin, about 5% to about 15% tomato, and about 5% to about 15% onion.

To produce the fruit or vegetable chips, the appropriate powders are mixed with dry ingredients, water and oil to form a dough. The other dry ingredients are comprised of a dry matter component and a moisture component. The dry matter component of any dry ingredient, as that term is used herein, is defined as the non-water components of that particular dry ingredient. For example, potato flakes have a potato flakes dry matter component and a potato flakes moisture component. The potato flakes dry matter component is defined as all of the non-water components that make up the potato flakes. The moisture component of each dry ingredient, as used herein, is defined as the water component of each dry ingredient. Thus, the moisture component for the potato flakes is defined as all of the water in the potato flakes. The moisture component of each dry ingredient will typically be less than about 10.5% by weight of the particular dry ingredient.

In one embodiment rice flour is included as an ingredient in the dough to maintain cohesiveness, contribute to the final product texture and reduce breakage of the final product. The rice flour has a rice dry matter component and a moisture component. In a more preferred embodiment, the rice flour is pre-gelatinized rice flour. Pre-gelatinized rice flour is rice flour that has a starchy component that has undergone an irreversible loss of molecular order, which allows it to more easily form pastes or gels when mixed with water. An example of pre-gelatinized rice flour suitable for use in the present invention can be obtained from Sage V Foods, under the brand RF GLX080.

In one embodiment, potato flakes are included as an ingredient to help the dough expand as it cooks, and give the final product its light, crispy texture. The potato flakes have a potato flakes dry matter component and a moisture component. Potato flakes are made from potatoes that have been cooked, mashed, and dried. For example, Idaho Pacific Corporation in Ririe, Id. produces potato flakes under the brand name Potato Flakes #124 that can be used as herein described.

In one embodiment, modified starch is included as an ingredient in the dough to aid cohesiveness, expansion, texture, and breakage reduction. The modified starch has a modified starch dry matter component and a moisture component. An example of a modified starch that can be used in the present invention is XPAND'R starch, available from AE Staley Manufacturing Company, headquartered in London, U.K.

In another embodiment, whole oat flour (one suitable example of which is available from Can-Oat Milling, headquartered in Manitoba, Canada) is included as an ingredient to improve the flavor of the final product and to enhance the nutritional value of the snack by adding whole grain fiber, vitamins and minerals. Alternatively, whole wheat flour, enriched wheat flour, or oat flour could be used. Flour has a flour dry matter component and a moisture component.

In still another embodiment, a mixture of mono-, di-, and/or tri-glycerides are included as an ingredient to reduce the “pillowing” or “blistering” effect that can take place during cooking by providing small vents that allow steam to escape while the snack chip is cooking. The mixture of glycerides has a dry matter component and a moisture component. In another embodiment, hard stock beads are used in place of the glycerides mixture to reduce pillowing or blistering. Hard stock beads, as used herein, are defined as small granules of glycerides which are made of hydrogenated edible oils or non-hydrogenated, high melting fraction of edible oil having a predetermined particle size distribution. The melting point of these hard stock glycerides is preferably between about 49° C. and about 82° C., more preferably between about 57° C. and about 79° C., and in the preferred embodiment between 60° C. and 71° C. Glycerides encompassing a range of Iodine Values less than 80 can meet these melting point needs. Examples of other lipids that can be used with the present invention include DATEMs, propylene glycol esters, polyglycerol esters, as well as waxes, sterols and other higher melting lipid compounds. One example of hard stock beads that are suitable for use in the present invention are described in U.S. Pat. No. 6,893,673—Method For Controlling Snack Product Blistering Through The Use Of Solid Lipid Particles, which is owned by the same assignee as the present application. As used herein, the term “glycerides” is defined as covering both the mixture of mono-, di- and/or tri-glycerides and hard stock beads.

The following general processing steps are followed to produce fruit or vegetable chips that can be used with the present invention. First, the fruit/vegetable powder and other dry ingredients are mixed in a first mixer. These ingredients are then combined with water and other liquid ingredients in a second mixer to produce a dough. The mixing may occur at room temperature, generally about 68° F. to about 86° F., but for the fruit chips preferably occurs at chilled temperatures, with the ambient temperature being between about 45° F. and 65° F. and with the mixer being chilled using water at above about 35° F. The dough preferably exits the second mixer between about 60° F. and about 80° F. Controlling the water temperature helps to control the dough temperature. The resultant dough in one embodiment comprises about 5% to about 15% modified starch, about 8% to about 20% rice flour, about 3% to about 15% flour, about 8% to about 20% potato flakes, at least 12% fruit powder, less than about 3% corn oil, less than about 1% glycerides and about 27% to about 37% water. The resultant dough in another embodiment comprises about 5% to about 15% modified starch, about 8% to about 20% rice flour, about 3% to about 15% flour, about 8% to about 20% potato flakes, at least 8% vegetable powder, less than about 3% corn oil, less than about 1% glycerides and about 27% to about 37% water.

The dough then undergoes a sheeting step, whereby the dough is compressed between at least one pair of counter rotating sheeter/cutter rollers that are located closely together, thereby providing a pinch point through which the dough is formed into sheets. The sheet of dough for the fruit chips is preferably between about 0.027 inches and about 0.035 inches thick, and more preferably about 0.033 inches thick after the sheeting step. The sheet of dough for the vegetable chips is preferably between about 0.031 inches and about 0.039 inches, and more preferably about 0.035 inches after the sheeting step. The preferred thickness is preferably accomplished by passing the dough through several successive stages of rollers, with each successive stage having the rollers located progressively closer together, more preferably 2, 3 or 4 stages of rollers. In some cases the rollers are preferably chilled to between about 35° F. and about 65° F. to reduce the likelihood of the dough sticking to the rollers.

The sheet of dough is then cut into a plurality of pieces, preferably using a rotary cutting unit. The pieces are then baked in a first oven at an oven temperature between about 350° F. and about 540° F. until they have a moisture content of about 5% to about 15%. The pieces are then baked in a second oven at an oven temperature between about 235° F. and about 280° F. to form fruit or vegetable chips having a final moisture content between about 2% and about 4% of the total product weight. The chips can then optionally be seasoned in an oil spray and seasoning tumbler and then packaged.

The fruit chip used in one preferred embodiment comprises about 10% to about 16% modified starch dry matter, about 15% to about 25% rice dry matter, about 5% to about 15% flour dry matter, about 15% to about 25% potato flakes dry matter, at least about 20% fruit solids, and less than about 4% water. In another embodiment, the fruit chip comprises about 12% to about 15% modified starch dry matter, about 18% to about 22% rice dry matter, about 8% to about 12% flour dry matter, about 18% to about 22% potato flakes dry matter, at least about 20% fruit solids, and less than about 4% water. The fruit chips deliver between about ½ and about 1 serving of fruit per ounce of fruit chips. Fruit chips that can be used in accordance with the present invention are currently sold by Frito-Lay North America under the trademark Flat Earth.

The resultant vegetable chip in one preferred embodiment comprises about 10% to about 16% modified starch dry matter, about 20% to about 30% rice dry matter, about 5% to about 15% flour dry matter, about 20% to about 30% potato flakes dry matter, at least 14% vegetable solids, and less than about 4% water. The resultant vegetable chip in another preferred embodiment comprises about 12% to about 14% modified starch dry matter, about 23% to about 27% rice dry matter, about 8% to about 12% flour dry matter, about 23% to about 29% potato flakes dry matter, at least 15% vegetable solids, and less than about 4% water.

In another aspect of the present invention, dried pieces of fruit or vegetables are included in the snack mixture disclosed herein. One type of dried fruit that can be used in accordance herein is an osmotically dehydrated, vacuum fried piece of fruit. Similarly, osmotically dehydrated, vacuum fried vegetables can be included in another embodiment. Another dried fruit that can be used is a freeze-dried fruit, and another dried vegetable that can be used is a freeze-dried vegetable. In either case, the dried fruit or vegetable pieces (or slices) comprise a moisture content less than 4% by weight.

Examples of pieces of fruit that can be osmotically dehydrated and vacuum fried, and used in the snack mixture, are apple slices, pineapple pieces and mango pieces. Examples of vegetable pieces that can be osmotically dehydrated and vacuum fried, and used in the snack mixture, are green beans and carrot slices. The method of making these fruit and vegetable pieces begins by partially dehydrating raw slices or pieces of each fruit or vegetable by osmotic dehydration (sometimes referred to as osmotic infusion). During the osmotic infusion, the pieces are preferably placed into a tank and submerged in an infusion solution. The infusion solution is a carbohydrate solution that comprises, for example, at least one of high maltose corn syrup, inulin, resistant dextrin, rice syrup, tapioca syrup, sorghum syrup, vitamins, salts, minerals, fibers, proteins, and juice concentrate. In a preferred embodiment, the infusion solution comprises a high maltose corn syrup solution with a Dextrose Equivalence of approximately 45. In one embodiment, the infusion solution has a Brix between about 20 and about 70. During infusion, the osmotic solute migrates into the pieces and replaces a portion of the water inside them. The infusion can occur at atmospheric pressure, under vacuum conditions, under elevated pressure, or a mixture of these conditions. The osmotic infusion process reduces the moisture content of the fruit and vegetable pieces by about 10% to about 15%.

Next, the pieces are fried under vacuum conditions. Frying the fruit and vegetable pieces under vacuum conditions allows lower cooking temperatures to be used, which reduces browning of the pieces during cooking and allows the dried pieces to retain more of their original color and flavor. Examples of vacuum fryers that can be used to make the dried fruit and vegetable pieces of the present invention are contained in U.S. Pat. Nos. 5,185,168 and 5,301,604. Generally, infused slices or pieces are weighed in frying baskets and then placed into the vacuum fryer. The door closes, the pressure is reduced, and the baskets are lowered into the oil for frying. Once the pieces reach the desired final moisture level, the baskets are raised for draining under vacuum, the vacuum is released, and the baskets are removed from the fryer. In one embodiment, the frying time is between about 5 minutes and about 20 minutes. The baskets are then flipped over for product removal.

The dried fruit and vegetable pieces contain between about 0.2% and 4% moisture by weight. Preferably, the moisture content of the dried pieces is between about 0.5% and about 1.5%. In one embodiment, the dried fruit pieces comprise about 25% to about 35% corn syrup, and preferably between about 28% and about 32% corn syrup by weight. In another embodiment, the dried vegetable pieces comprise about 23% to about 43% corn syrup, and preferably between about 30% to about 36% corn syrup. In one embodiment, when the fruit is vacuum fried, the oil content of the fruit pieces is between about 15% and about 31% by weight. In a preferred embodiment, the oil content of the fruit is between about 19% and about 23% by weight. In another embodiment, when the vegetable pieces are vacuum fried, the oil content of the vegetable pieces is between about 18% and about 37% by weight. In a preferred embodiment, the oil content of the vegetable pieces is between about 22% and about 29% by weight. The vacuum fried fruit pieces deliver between about 1 and about 2 servings of fruit per ounce of vacuum fried fruit, and the vacuum fried vegetable pieces deliver between about 1 and about 2 servings of vegetables per ounce of vacuum fried vegetables. As used herein, the term “osmotically dehydrated, vacuum fried fruit” is defined as fruit or pieces of fruit that have first been partially dehydrated by osmotic infusion of a carbohydrate solution, and then fried at pressures below atmospheric pressure. Similarly, the term “osmotically dehydrated, vacuum fried vegetable” is defined as vegetables or pieces of vegetables that have first been partially dehydrated by osmotic infusion of a carbohydrate solution, and then fried at pressures below atmospheric pressure.

Freeze-dried fruit and vegetables are readily available commercially, and making freeze-dried fruit and vegetables used in the snack mixture herein can be accomplished using any method known in the art. Examples of freeze-dried fruit used herein include, whole raspberries, strawberry slices and banana slices. Freeze-dried vegetables can include freeze dried bell peppers, sweet corn, green peas, legumes and tomatoes. Freeze-dried fruits can provide between about 2 and about 4 servings of fruit per ounce of freeze-dried fruit. Freeze dried vegetables can provide between about 2 and about 4 servings of vegetables per ounce of freeze dried vegetables In one embodiment, the freeze-dried fruit and vegetables comprise a moisture content less than 4% by weight.

The final component of the snack mixture of the present invention is a grain component. The grain component is a healthy item that provides the consumer with different but complimentary flavors and textures. It also lowers the per ounce price of the snack mixture. This component generally comprises a sweet, crispy grain-based snack item when combined with the dried fruit. When combined with dried vegetables, a savory, crispy grain based snack item may compliment the vegetable components. As used herein, the term “grain-based snack item” is a snack item that comprises at least 50% by weight of at least one of rice flour, whole wheat flour, whole oat flour, enriched wheat flour, whole corn, corn meal and whole rice flour, and a moisture content less than about 3% by weight. Generally, the foregoing ingredients are combined with other dry ingredients and water to form a dough. The dough is sheeted and cut into discrete pieces, which are dried to a moisture content less than 4% by weight. Examples of grain-based snack items that can be used in the snack mixture include chocolate flavored rice cakes, and multi-grain chips, honey flavored pretzels, and toasted corn chips sold by Frito-Lay North America, Inc. under the trademarks SunChips, Rold Gold, and Baked Doritos, respectively.

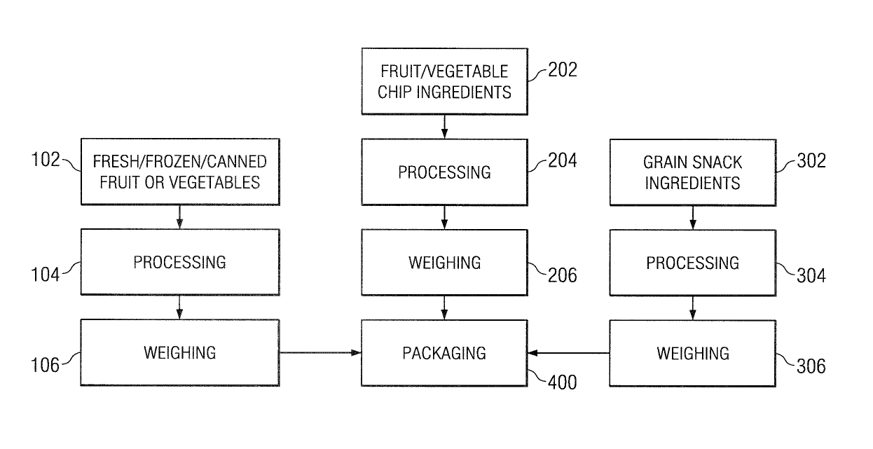

FIG. 1 depicts a flowchart for one embodiment of the present invention. As shown therein, each of the different components of the snack mixture are processed in different streams, weighed, and then packaged together. To make the dried fruit or vegetable pieces, raw pieces 102 are processed 104 as described herein above, and weighed 106 before packaging 400. The fruit or vegetable chip ingredients 202 are also processed 204 as described herein, and weighed 206 before packaging 400. The grain based snacks are made by processing 304 the grain ingredients 302 as described herein, and weighing 306 the grain based snacks before packaging 400. This represents one embodiment of the present invention, it being understood that other intermediate steps may also occur. For example, each of the components may be manufactured at different locations and shipped to a central location before weighing and packaging. In that case, a shipping step may be included between the processing steps 104, 204, 304 and weighing steps 106, 206, 306.

In one embodiment, the snack mixture of the present invention comprises by weight about 30% to about 60% fruit chips or vegetable chips, about 10% to about 40% dried fruit or vegetable pieces, and about 25% to about 40% grain-based snack items. In a preferred embodiment, the dried fruit pieces comprise at least one of freeze-dried fruit pieces and osmotically dehydrated, vacuum fried fruit pieces. In another preferred embodiment, the dried vegetable pieces comprise at least one of freeze-dried vegetable pieces and osmotically dehydrated, vacuum fried vegetable pieces. In another embodiment, the snack mixture comprises at least about 3% freeze-dried fruit pieces by weight, or at least about 3% freeze-dried vegetable pieces by weight. In still another embodiment, the snack mixture comprises at least about 15% osmotically dehydrated, vacuum fried fruit or vegetable pieces by weight.

Because all of the discrete snack pieces used in the mixture of the present invention comprise a moisture content less than 4% by weight, unlike some of the components of the prior art, all of the components of the present invention are preferably crispy. Using all crispy components allows this snack mixture to be packaged in the same headspace and enjoy a longer shelf life than mixtures in the prior art because moisture will not migrate from one crispy food to another in the present invention.

The snack mixture of the present invention is not only nutritious, but it also scores well in consumer tests. Specifically, in one embodiment, the snack mixture has an Overall Acceptability Score of at least 6.0. As used herein, the term “Overall Acceptability Score” means the average rating given by at least 60 consumers on a 9-point scale, with 1 being the lowest score and 9 being the highest score, in response to the question “How well do you like this sample OVERALL?”, after eating at least one of each component of the snack mix.

### FIRST EXAMPLE

A first snack mixture was prepared in accordance with the present invention. The table below illustrates the ingredients and their relative amounts that were used to make five ounces of the snack mixture:

TABLE 2

| | Weight % of | Total Wt. of |
|---|---|---|
| Component | Component | Component (g) |
| Apple Cinnamon Fruit Chips | 36% | 51.0 |
| Vacuum Fried Apple Slices | 25% | 35.4 |
| Multigrain Chips | 35% | 49.6 |
| Freeze-Dried Raspberries | 4% | 5.7 |
| (whole) | | |

### SECOND EXAMPLE

A second snack mixture was prepared in accordance with the present invention. The table below illustrates the ingredients and their relative amounts that were used to make five ounces of the snack mixture:

TABLE 3

| | Weight % of | Total Wt. of |
|---|---|---|
| Component | Component | Component (g) |
| Wild Berry Fruit Chips | 40% | 56.7 |
| Chocolate Flavored Rice | 39% | 55.3 |
| Snacks | | |
| Freeze-Dried Strawberry | 3% | 4.3 |
| Slices | | |
| Vacuum Fried Apple Slices | 18% | 25.5 |

### THIRD EXAMPLE

A third snack mixture was prepared in accordance with the present invention. The table below illustrates the ingredients and their relative amounts that were used to make five ounces of the snack mixture:

TABLE 4

| | Weight % of | Total Wt. of |
|---|---|---|
| Component | Component | Component (g) |
| Peach Mango Fruit Chips | 48% | 68.0 |
| Honey Wheat Flavored | 27% | 38.3 |
| Pretzels | | |
| Vacuum Fried Pineapple | 13% | 18.4 |
| Pieces | | |
| Vacuum Fried Mango Pieces | 12% | 17.0 |

### FOURTH EXAMPLE (HYPOTHETICAL)

A fourth snack mixture could be prepared in accordance with the present invention. The table below illustrates the ingredients and their relative amounts that could be used to make five ounces of the snack mixture:

TABLE 5

| | Weight % of | Total Wt. of |
|---|---|---|
| Component | Component | Component (g) |
| Harvest Cheddar Vegetable | 40% | 56.70 |
| Chips | | |
| Baked Toasted Corn Chips | 35% | 49.61 |
| Vacuum Fried Green Beans | 20% | 28.35 |
| Freeze-Dried Bell Pepper | 5% | 7.09 |

The snack mixtures described in the above examples contain at least ½ serving of fruit or vegetables, and meet or exceed the other preferred nutritional goals. Specifically, the snack mixtures disclosed above have, per 1 ounce serving, less than 5 grams of fat, 1 gram or less of saturated fat, zero trans-fatty acids, less than 25% calories from added sugar, and no more than 270 milligrams of sodium. In sum, the examples produce healthy, nutritious snack mixtures that were high in fruit or vegetable content. Also, the snack mixtures have an Overall Acceptability Score of at least 6.0.

What is claimed is:

1. A snack mixture comprising by weight:
about 30% to about 60% fruit chips or vegetable chips, wherein said fruit chips comprise by weight:
about 10% to about 16% modified starch dry matter;
about 15% to about 25% rice dry matter;
about 5% to about 15% flour dry matter;
about 15% to about 25% potato flakes dry matter;
at least about 20% fruit solids; and
less than 4% water; or
wherein said vegetable chips comprise by weight:
about 10% to about 16% modified starch dry matter;
about 20% to about 30% rice dry matter;
about 5% to about 15% flour dry matter;
about 20% to about 30% potato flakes dry matter;
at least 14% vegetable solids; and
less than 4% water; and
about 25% to about 40% grain based snack pieces, said grain based snack pieces comprising by weight:
at least about 50% of at least one of rice flour, whole wheat flour, whole oat flour, enriched wheat flour, whole corn, corn meal and whole rice flour; and
a moisture content less than 4%; and
about 10% to about 40% dried fruit pieces or dried vegetable pieces comprising a moisture content less than 4% by weight.

2. The snack mixture of claim 1 further comprising an Overall Acceptability Score of at least 6.0.

3. The snack mixture of claim 1 wherein said dried fruit pieces comprise at least one of freeze-dried fruit pieces and osmotically dehydrated, vacuum fried fruit pieces.

4. The snack mixture of claim 3 further comprising by weight at least 3% said freeze-dried fruit pieces.

5. The snack mixture of claim 3 further comprising by weight at least about 15% said osmotically dehydrated, vacuum fried fruit.

6. The snack mixture of claim 1 further comprising at least ½ serving of fruit or ½ serving of vegetables per ounce of said snack mixture.

7. The snack mixture of claim 1 wherein said dried vegetable pieces comprise at least one of freeze-dried vegetable pieces and osmotically dehydrated, vacuum fried vegetable pieces.

8. The snack mixture of claim 7 further comprising by weight at least 3% said freeze-dried vegetable pieces.

9. The snack mixture of claim 7 further comprising by weight at least about 15% osmotically dehydrated, vacuum fried vegetables.

10. The snack mixture of claim 1 further comprising at least ½ serving of vegetables per ounce of said snack mixture.

11. The snack mixture of claim 1 additionally comprising:
less than about 5 grams of fat;
about 1 gram or less of saturated fat;
about 0 grams of trans-fatty acids;
less than about 25% calories from added sugar; and
less than 270 milligrams of sodium.

12. The snack mixture of claim 1 further comprising at least one serving of fruit or one serving of vegetables per ounce of said snack mixture.

13. The snack mixture of claim 1 wherein said fruit chips further comprise at least ½ serving of fruit per ounce of said fruit chips, or wherein said vegetable chips further comprise at least ½ serving of vegetables per ounce of said vegetable chips.

14. A method of making a snack mixture, said method comprising:
providing fruit chips or vegetable chips, wherein said fruit chips comprise by weight:
about 10% to about 16% modified starch dry matter;
about 15% to about 25% rice dry matter;
about 5% to about 15% flour dry matter;
about 15% to about 25% potato flakes dry matter;
at least about 20% fruit solids; and
less than 4% water; or
wherein said vegetable chips comprise by weight:
about 10% to about 16% modified starch dry matter;
about 20% to about 30% rice dry matter;
about 5% to about 15% flour dry matter;
about 20% to about 30% potato flakes dry matter;
at least 14% vegetable solids; and
less than 4% water; and
providing grain-based snack pieces, wherein said grain-based snack pieces comprise by weight:
at least about 50% of at least one of rice flour, whole wheat flour, whole oat flour, enriched wheat flour, whole corn, corn meal and whole rice flour; and
a moisture content less than 4%;
providing dried fruit pieces or dried vegetable pieces comprising a moisture content less than 4% by weight;
mixing said fruit chips or said vegetable chips, said grain based snack pieces, and said dried fruit pieces or said dried vegetable pieces to produce said snack mixture, wherein said snack mixture comprises:
about 30% to about 60% said fruit chips or said vegetable chips;
about 25% to about 40% said grain based snack pieces; and
about 10% to about 40% said dried fruit pieces or said dried vegetable pieces.

15. The method of claim 14 wherein said providing dried fruit pieces further comprises:
providing at least one of osmotically dehydrated, vacuum fried fruit pieces and freeze-dried fruit pieces.

16. The method of claim 15 wherein said snack mixture produced by said mixing further comprises at least 3% by weight said freeze-dried fruit pieces.

17. The method of claim 15 wherein said snack mixture produced by said mixing further comprises at least 15% by weight said osmotically dehydrated, vacuum fried fruit pieces.

18. The method of claim 14 wherein said providing dried vegetable pieces further comprises:
providing at least one of osmotically dehydrated, vacuum fried vegetable pieces and freeze-dried vegetable pieces.

19. The method of claim 18 wherein said snack mixture produced by said mixing further comprises at least 3% by weight said freeze-dried vegetable pieces.

20. The method of claim 18 wherein said snack mixture produced by said mixing further comprises at least 15% by weight said osmotically dehydrated, vacuum fried vegetable pieces.

21. The method of claim 14 wherein said snack mixture further comprises an Overall Acceptability Score of at least 6.0.

22. The method of claim 14 wherein said snack mixture further comprises:
less than about 5 grams of fat;
about 1 gram or less of saturated fat;
about 0 grams of trans-fatty acids;
less than about 25% calories from added sugar; and
less than 270 milligrams of sodium.

23. The method of claim 14 wherein said snack mixture further comprises at least about ½ serving of fruit or ½ serving of vegetables per ounce of said snack mixture.

24. The method of claim 14 wherein said snack mixture further comprises at least about one serving of fruit or one serving of vegetables per ounce of said snack mixture.
